(19) United States
(12) Patent Application Publication
(10) Pub. No.: US 2017/0327918 A1
(43) Pub. Date: Nov. 16, 2017

(54) PROCESS FOR OBTAINING A PISTON RING AND INTERNAL COMBUSTION ENGINE

(71) Applicants: Mahle Metal Leve S/A, Jundiai - Sp (BR); Mahle International GmbH, Stuttgart (DE)

(72) Inventors: Paulo J. Da Rocha Mordente, Jundiai, Sao Paulo (BR); Daniel Mock, Stuttgart (DE); Stephanie Koenig, Stuttgart (DE); Daniel Lopez, Stuttgart (DE)

(21) Appl. No.: 15/534,959

(22) PCT Filed: Dec. 8, 2015
(86) PCT No.: PCT/EP2015/078989

§ 371 Date: Jun. 9, 2017

(30) Foreign Application Priority Data
Dec. 11, 2014 (BR) 10 2014 031075 4

(51) Int. Cl. C21D 9/40; C23C 8/66; C21D 1/09; F16J 9/26; F16J 9/20

(52) U.S. Cl. CPC C21D 9/40; F16J 9/26; F16J 9/206; C21D 1/09; C23C 8/66; C21D 2221/10

(57) ABSTRACT

A process for obtaining a piston ring may include providing a piston ring of an internal combustion engine and submitting a surface of the piston ring to a laser surface heat treatment. The surface may be a sliding surface of the piston ring. The piston ring may be a one piece piston ring and/or a scrapper ring.

### CROSS REFERENCE TO RELATED APPLICATIONS

This application claims priority to Brazilian Patent Application No. 10 2014 031075 4 filed on Dec. 11, 2014, and the International Patent Application No. PCT/EP2015/078989, filed on Dec. 8, 2015, the contents of which are hereby incorporated by reference in their entirety.

### TECHNICAL FIELD

The present invention relates, in a general manner, to a component of an internal combustion engine and, more specifically, the present invention relates to a one piece oil ring having improved wear resistance and a process for obtaining such piston ring.

### BACKGROUND

Internal combustion engines, such as the engines employing the known Otto or Diesel cycles, are widely and commonly utilized in vehicles destined for the movement both of persons and of goods, such as passenger, haulage and freight vehicles, including lorries and locomotives. In summary, these engines utilize a fuel having a high hydrocarbon content, such as fossil fuels and/or those originating from renewable sources, to transform the thermal energy from the burning of the fuel into kinetic energy.

The construction of an internal combustion engine is well known and consists, basically, of a piston moving within the interior of a cylinder associated with a crankshaft. On the upper side of the piston there is provided a combustion chamber comprising, among other elements such as spark plugs and/or injection nozzles, at least one intake valve and one exhaust valve. The piston, in turn, generally comprises three rings in contact with the cylinder liner, the upper two rings, that is to say those most proximal to the head of the piston whereat the compression of the combustion gases in the chamber is realized, have the function of ensuring the sealing of the mixture and preventing the escape both of the mixture and of the combustion gases to the interior of the block and, by virtue thereof, they are generally denominated “compression rings”. The third ring, normally located below the two compression rings, has the objective of removing or “scraping” the oil film when the piston descends, to prevent the burning of oil and, in this manner, to reduce moreover the emission of gases. This ring is generally denominated “scraper ring”.

The components and operation of an internal combustion engine, both of the Otto cycle and of the Diesel cycle, are of common knowledge to those versed in the art, for which reason greater explanation is unnecessary in the present descriptive memorandum.

Growing concern exists today in respect of the reduction of the emissions produced by internal combustion engines, responsible for a large part of the release of CO₂ into the atmosphere. Climate change is one of the most relevant current environmental challenges, having possibly grave consequences. This problem is being caused by the intensification of the greenhouse effect which, in turn, is related to the increase in the concentration in the atmosphere of greenhouse gases (GGs), among them carbon dioxide.

In recent years, with the objective of minimizing the emission into the environment of harmful gases, such as carbon monoxide (CO), hydrocarbon gases (HCs), nitrogen oxides (NOx), together with particulate materials and/or other GGs, a series of technologies has been incorporated into internal combustion engines. The reduction in emissions of gases is related, among other factors, to the increase in the thermal performance of engines and, consequently, the reduction in the specific consumption of fuel.

In this sense, technologies such as electronic injection, the catalyst, and particulate matter filters are, today, very widespread and employed in an almost obligatory manner in all internal combustion engines. Other more recent technologies, such as the direct injection of fuel, the common rail technology for engines utilizing the Diesel cycle, and the utilization on a greater scale of technologies known for a long time, such as mechanical compressors or turbocompressors, are also becoming associated, with the objective of increasing energy efficiency and complying with increasingly rigid emission regulations.

As a consequence, combustion engines are developing greater power per volume of displacement of the piston within the cylinder, commonly referred to as specific power output. The performance of an Otto cycle combustion engine in the decade of the 1980s attained, on average, 50 HP/l, whereas today it may easily attain in excess of 100 HP/l. This means that the combustion pressure within the interior of the cylinders has increased considerably, this also meaning that combustion engines are working under greater mechanical stresses, with faster rotation and higher combustion temperature. Consequently, the components thereof must likewise be dimensioned to support these harsher operating conditions in order both to ensure the reliability of the assembly and to sustain the expected working life, today estimated as being approximately 300 000 km for Otto cycle engines in motorcars.

This greater operational stress is translated, likewise, into greater stress suffered by the components, inter alia the piston and the rings associated with the piston. With the greater degrees of compression, combustion pressure, temperature and rotation, the rings also exercise greater pressure upon the piston and upon the walls of the cylinder, likewise leading to greater wear or fatigue of the rings, which may increase the play existing between the ring and the cylinder and, in this manner, possibly causing problems related with the wear of the cylinder liner and/or of the piston itself, oil leakage, increase in fuel and/or oil consumption and, even, the rupture of the ring.

The present invention has the objective of overcoming these, and other, drawbacks encountered in the state of the art.

### SUMMARY

Consequently, a first object of the present invention is to provide a one piece scraper ring having characteristics of improved wear resistance.

An additional object of the invention is to provide a process for obtaining the aforementioned scraper ring having characteristics of improved strength.

Having the objective of satisfying, inter alia, the foregoing objects, the present invention relates to a product and a related process for obtaining a one piece scraper ring. According to a first aspect of the invention, the process comprises the stages of:
a) providing a piston ring of an internal combustion engine; and
b) submitting the sliding surface of the said ring to a laser surface heat treatment.

According to additional and/or alternative embodiments of the invention, the following characteristics, separately or in technically possible combinations, may also be present:
said sliding surface is the contact surface of the ring with the cylinder liner;
said one piece piston ring is a one piece scraper ring comprising a U shape taken in relation to the cross-section thereof;
said surface is at least one of the surfaces formed by the U shaped profile and which is destined to be maintained in contact with the cylinder liner;
said surface is the two surfaces formed by the U shaped profile and which are destined to be maintained in contact with the cylinder liner;
said ring is realized in carbon steel or alloyed steel;
said carbon steel comprises from 0.4 to 0.95% by weight of carbon, among other elements and inevitable impurities;
the said alloyed steel comprises Cr, Mo, Nb, among other elements;
said laser surface heat treatment is a quenching treatment;
said laser surface heat treatment is a case hardening treatment;
said laser surface heat treatment is followed by a tempering treatment;
said ring is subjected, prior to the laser surface heat treatment, to stages of shaping and/or machining and/or heat treatment.

The invention furthermore relates to a piston ring obtained by the aforedescribed process and to an internal combustion engine comprising at least one ring, the ring being obtained by a process such as defined above.

### BRIEF DESCRIPTION OF THE DRAWINGS

The invention shall now be described in relation to the particular embodiments thereof, making reference to the attached figures. Such figures are schematic and the dimensions and proportions thereof may not correspond to the reality by virtue of the fact that the sole intention thereof is to describe the invention in a didactic manner, they not imposing any limitation whatsoever other than those defined in the claims below. Certain technical characteristics may have been omitted from the figures for purposes of greater clarity and comprehension, wherein:

FIG. 1 is a partial perspective view of a piston ring, in particular a one piece scraper ring of a piston;

FIG. 2 is a flow diagram of the flow of the process of manufacture of the present invention;

FIG. 3A is a spatial schematic view of the laser beam treating the one piece scraper ring on one sliding surface;

FIG. 3B is a schematic cross-section view of the one piece scraper ring having been treated by the laser on one side and undergoing laser treatment on the second side of the same ring, according to FIG. 3A;

FIG. 4 is an image obtained by an optical microscope showing the depth of the material modified as a function of the laser hardening treatment;

FIG. 5A is an image obtained by an optical microscope showing the depth of the material modified as a function of the laser case hardening;

FIG. 5B is an image of the analysis of the measurement of the carbon content for laser carburized carbon steel; and

FIG. 6 is a graphic showing comparative wear performance for two versions of rings, laser treated and non-laser treated.

### DETAILED DESCRIPTION

The invention shall now be described in relation to the particular embodiments thereof. Specific embodiments are described in detail, it being understood that they shall be considered as an exemplification of the principles thereof and are not destined to restrict the invention to solely that described in the present memorandum. It shall be recognized that the different teachings of the embodiments discussed below may be employed separately or in any appropriate combination to yield the same technical effects. The reference numerals are repeated for the same technical characteristics throughout the figures.

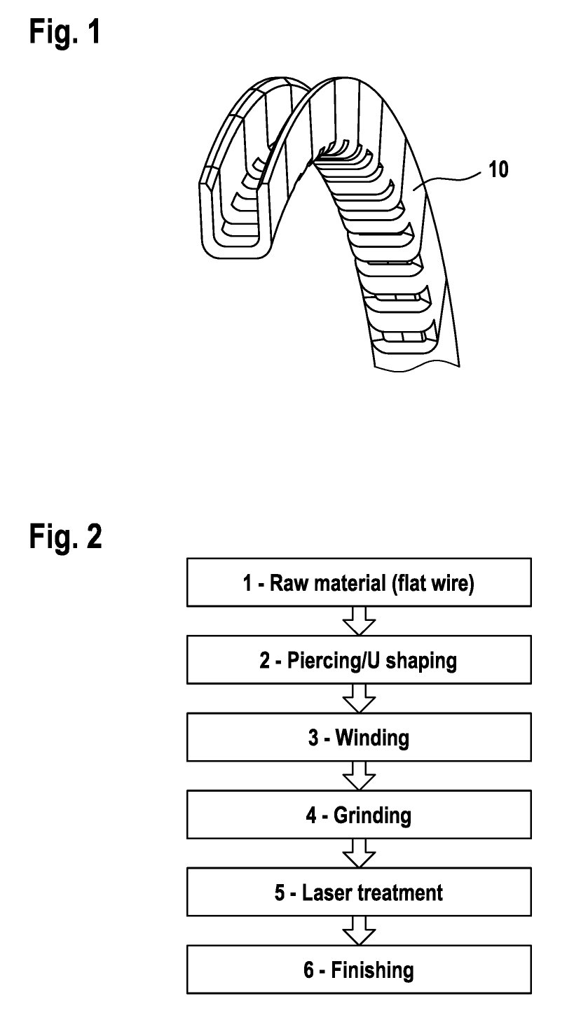

FIG. 1 shows a partial perspective view of a ring (10) of an internal combustion engine and, in particular, a one piece scraper ring of a piston of an internal combustion engine. As aforementioned, the oil ring has the purpose of removing the oil film formed between the cylinder liner and the piston with the objective of preventing the burning of oil during combustion and, in this manner, likewise preventing the consumption of oil and the emission of polluting gases. A scraper ring as shown in FIG. 1 is already known in the state of the art, for example in the patent publication WO 2014/066965, incorporated herein as reference.

FIG. 2 shows the process of manufacture for one piece oil control rings. The principal stages comprise piercing and forming (2) the U shape by the die process, obtained from a flat wire (1). Subsequently, the wire in a U shape is spirally wound in the form of a ring (stage 3). The final dimensions of the ring are adjusted by a grinding operation (4). Properties of the material of the sliding surface (33) are modified by laser treatment, the matter of a specific embodiment of this invention, in order that the finishing of the sliding surface may be executed by machining the same, utilizing a process of polishing or of grinding or of burnishing (6). These stages of a process for the obtainment of a piston ring, except for stage 5, the object of the present invention, are already known in the state of the art.

The invention proposes that the contact surface (33, 33′) with the cylinder liner be submitted to a hardening process utilizing laser radiation.

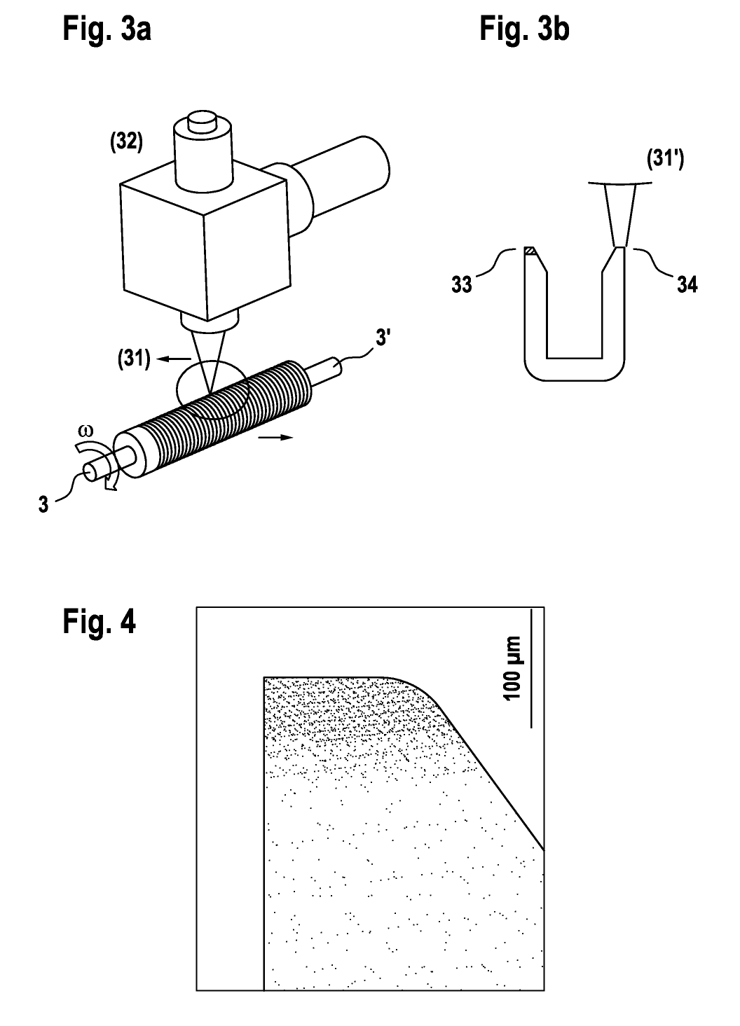

In the first embodiment of the invention, the use is proposed of laser radiation for quenched carbon or alloyed steel. In order to obtain such a hardening effect at least 0.3% of the equivalent C content is required. For the purposes of industrial production the rings are mounted on a mandrel rotating at a constant angular velocity (ω) about an axis (3-3′) (FIGS. 3a and 3b). For the purposes of the present invention an ω was utilized in the band capable of providing a relative velocity between the laser beam and the peripheral surface of the ring under treatment (33 and 34) from 25 mm/sec. to 105 mm/sec. A further key parameter utilized for the hardening of the sliding surface is the power density of the incident laser beam. The laser beam was adjusted for operation in the band from 20 to 180 W/mm². It must be noted that different types of laser, that is to say solid diode or CO₂ laser, may be used for obtaining similar results. However the power density and the relative velocity between the laser beam and the surface under treatment must be adjusted as a function of the absorption of the laser radiation. In order to achieve the aforedescribed power density band, different geometries of laser points may be used, that is to say incident projection of the laser beam onto the surface under treatment. The point of the laser beam may be adjusted by laser optic (32), for example rectangular, circular, elliptic and other formats may be produced by an appropriate laser optic (32).

FIG. 4 shows a partial cross-section of the region treated on the sliding surface obtained by the process of the invention. It has been chemically etched in order to reveal the treated region. The sample shown was generated in a single pass of the laser beam over the surface to be modified with the power density adjusted to 100 W/mm² and relative speed of 70 mm/sec. The hardness of the material in the P region attained 1000 HV_{0.05} whilst the material of the nucleus (region C) is of 550 HV_{0.05}. The depth of the modified coating attained 60 μm. The depth of the hardened coating may be increased through raising the power density or diminishing the relative speed furnished by the rotational movement of the rings under treatment.

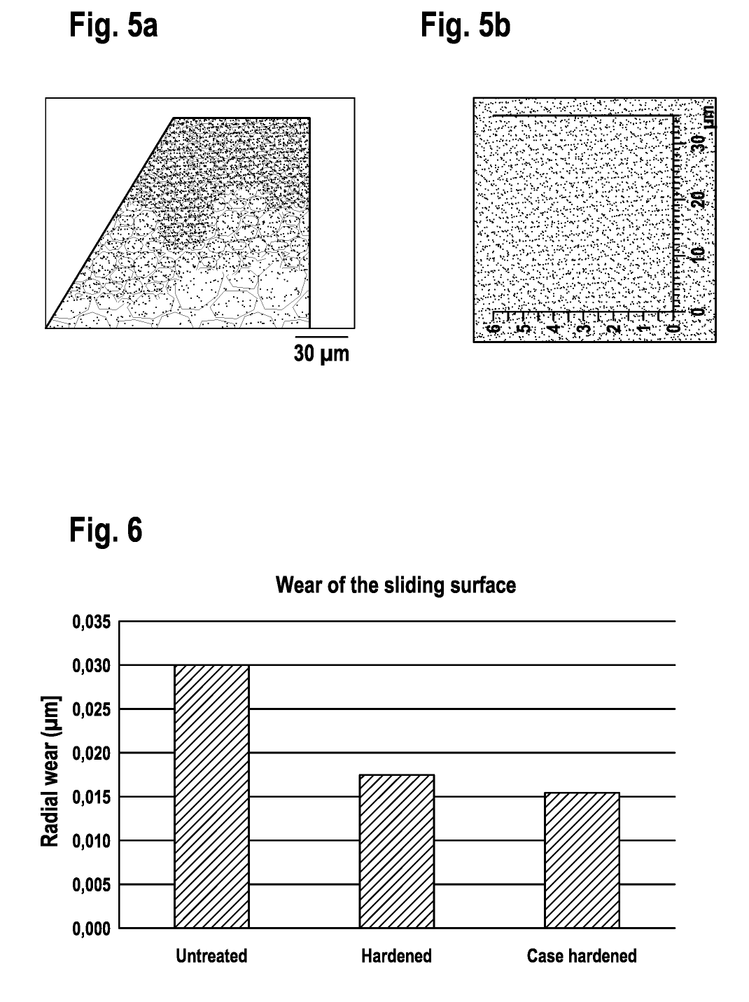

In a second embodiment of the invention, the raised temperature generated by the laser beam is used to produce the diffusion of an external chemical material upon the surface. The cross-section shown in FIG. 5a is an example of carburized surface caused by the laser. In this case adjustment to a relative speed of less than 70 mm/sec. is required. Such lower speed permits a higher temperature and a longer time for diffusion of the carbon applied upon the surface to be carburized. Typically, lampblack is applied upon the surface to be laser treated. The example shown in FIG. 5a was generated by applying a power density of 200 W/mm² and a relative speed of 40 mm/sec. Differing from the laser hardening executed in a single pass, the case hardening was carried out repeating the interaction of the laser beam on the surface to be carburized. Experiments have shown that solely 5 passes may provide 5 μm of carbon diffusion. The carbon diffusion diminishes as a function of the depth of the carburized coating and the 10 microns of carburized coating shown in FIG. 5b was obtained utilizing 15 passes of the laser beam upon the same region. Considerably extending the duration of the time for treatment, thicker carburized coatings may be obtained. A very long treatment time (or many passes) may generate localized melting on the surface under treatment, consequently an additional reduction in the power density may be used to control such undesirable effects in order to obtain a carburized depth exceeding 50 μm.

According to the invention, the development of wear of the one piece scraper ring obtained by the process of manufacture described in the first and second embodiments was high. The wear performance was characterized by the fact of maintaining a set of one piece oil control rings (those three different versions, uncoated, hardened and carburized) in the same disposition and testing reciprocating sliding movement under lubricated conditions. Abrasive particles were intentionally added into the oil to accelerate the wear of the sliding surface of the one piece control rings. Careful selection of the rings under test was realized to provide a good comparative evaluation, considering that modification of the surface to be the sole characteristic influencing the wear performance. In other words, the geometry, the contact pressure of the sliding surface and the test conditions were exactly the same for those three different versions of the rings under test.

Carburized sliding surfaces, together with hardened surfaces, present improved wear resistance when compared with untreated surfaces. FIG. 6 shows radial wear measured by superimposing the profiles, prior to and subsequent to the test, for the sliding surfaces (upper and lower contacts of the one piece scraper ring). The modification of the surface by carburization or hardening had the objective of reducing the wear on the sliding surfaces. The verification shows a reduction in wear of 40%, considering the untreated surface.

In spite of the invention having been described in relation to the particular embodiments thereof, those versed in the art will be capable of realizing alterations or combinations not contemplated above without, however, deviating from the teachings described herein, in addition to extending to other applications not considered in the present descriptive memorandum. For example, in spite of the embodiment herein described making reference to an oil ring of an internal combustion engine, it is obvious that the process of the invention may be applied to other parts, the improved surface hardness characteristic whereof may be desirable, such as the compression ring. Consequently, the claims appended shall be interpreted as covering each and every equivalent falling within the principles of the invention.

1. A process for obtaining a piston ring comprising:
providing a preformed ring for an internal combustion engine; and
submitting a sliding surface of said ring to a laser surface heat treatment.

2. The process as claimed in claim 1, wherein said sliding surface is a contact surface of the ring with a cylinder liner.

3. The process as claimed in claim 1, wherein providing said ring includes providing a one piece scraper ring having a U-shaped profile with respect to a cross-section thereof.

4. The process as claimed in claim 3, wherein said sliding surface is at least one surface defined by the U-shaped profile and is configured to maintain contact with a cylinder liner of the internal combustion engine.

5. The process as claimed in claim 3, wherein said sliding surface includes two surfaces provided by the U-shaped profile and configured to contact a cylinder liner of the internal combustion engine.

6. The process as claimed in claim 1, wherein said ring is composed of a carbon steel.

7. The process as claimed in claim 1, wherein said ring is composed of alloyed steel including Cr, Mo, and Nb.

8. The process as claimed in claim 1, wherein submitting said sliding surface to said laser surface heat treatment includes quenching via a laser beam.

9. The process as claimed in claim 1, wherein submitting said sliding surface to said laser surface heat treatment includes case hardening said sliding surface via a laser beam.

10. The process as claimed in claim 1, further comprising tempering said ring after submitting said sliding surface to said laser surface heat treatment.

11. The process as claimed in claim 1, further comprising, prior to said laser surface heat treatment, subjecting said ring to at least one of shaping, machining and heat treatment.

12. A piston ring, of an internal combustion engine, comprising: a steel U-shaped ring having a laser radiated case hardened sliding surface.

13. An internal combustion engine, comprising:
at least one piston;
at least one piston ring arranged in a groove of the at least one piston, said at least one piston ring composed of a steel material and having a laser radiated hardened sliding surface.

14. The process as claimed in claim 1, wherein submitting said sliding surface to said laser surface heat treatment includes subjecting said sliding surface to an incident laser beam having a power density of 20 to 180 W/mm².

15. The process as claimed in claim 1, wherein submitting said sliding surface to said laser surface heat treatment includes rotating said sliding surface relative to an incident laser beam at a speed of 25 mm/second to 105 mm/second.

16. The process as claimed in claim 1, further comprising applying an external chemical material onto said sliding surface, wherein submitting said sliding surface to said laser surface heat treatment includes diffusing said external chemical material upon said sliding surface by an incident laser beam.

17. The process as claimed in claim 1, wherein submitting said sliding surface to said laser surface heat treatment includes applying a carbon material onto said sliding surface and carburizing said sliding surface by an incident laser beam at a relative rotational speed of less than 70 mm/second.

18. The process as claimed in claim 1, wherein submitting said sliding surface to said laser surface heat treatment includes subjecting said sliding surface to an incident laser beam having a rectangular geometry, a circular geometry or an elliptical geometry.

19. The process as claimed in claim 1, wherein submitting said sliding surface to said laser surface heat treatment includes subjecting said sliding surface to an incident laser beam having a power density of 20 to 180 W/mm² while rotating said sliding surface relative to said incident laser beam at a speed of 25 mm/second to 105 mm/second.

20. The process as claimed in claim 6, wherein said carbon steel includes from 0.4 to 0.95% by weight of carbon.
